(19) United States
(12) Patent Application Publication
(10) Pub. No.: US 2026/0350170 A1
(43) Pub. Date: Nov. 5, 2026

(54) AI Aware

(71) Applicant: Robert Paul Quinn, George Town (KY)

(72) Inventor: Robert Paul Quinn, George Town (KY)

(21) Appl. No.: 19/198,000

(22) Filed: May 3, 2025

(51) Int. Cl. G06F 21/57; G06F 18/24

(52) U.S. Cl. CPC G06F 21/57; G06F 18/24765; G06F 2221/032

(57) ABSTRACT

A real-time AI awareness and user override system receives digital communication input from text, audio, image, video, browser, messaging, social-media, or live communication sources. A detection engine analyzes content-origin, identity, metadata, linguistic, biometric, behavioral, and manipulation signals. A classification module classifies the communication as likely human, artificial-intelligence-assisted, artificial-intelligence-generated, manipulated, suspicious, or inconclusive. A user interface displays a trust indicator and explanatory alert. An override module enables protective actions including freeze, block source, report, replay, or user-authorized continuation. The system may operate through a mobile app, browser extension, messaging integration, share extension, or video-call overlay.

### CROSS-REFERENCE TO RELATED APPLICATIONS

This application claims no priority to any earlier application unless separately identified in an application data sheet or other filing submitted in this application.

### FIELD OF THE INVENTION

The present disclosure relates generally to computer-based systems for detecting artificial-intelligence-originated, artificial-intelligence-assisted, or manipulated digital communications and media, and more particularly to user-facing systems that classify communication trust signals, present visual alerts, and permit a user to freeze, override, or block suspicious interactions in real time.

### BACKGROUND OF THE INVENTION

Artificial intelligence tools are increasingly capable of generating realistic text, audio, images, video, social posts, and interactive communications. Such communications may appear to be human, may imitate known persons, or may manipulate users through emotional pressure, urgency, fraud, misinformation, or impersonation.

Existing detection tools often operate after the content has already been consumed, shared, or acted upon. Many systems also provide a technical score without a practical user interface that tells an ordinary user when to pause, when to proceed, or when to take a protective action.

There is a need for a real-time awareness system that can evaluate communications across text, audio, video, browser, message, and social-media environments; classify whether a communication appears human, artificial, or manipulated; display a clear visual indicator; and enable protective user controls such as freeze, override, and block-source functions.

### SUMMARY OF THE INVENTION

In one embodiment, an AI AWARE system receives communication input from a user device, analyzes one or more content-origin signals, and classifies the communication according to trust or risk categories. The categories may include human, AI-generated, AI-assisted, manipulated, suspicious, or inconclusive states.

In another embodiment, a detection engine evaluates text, audio, image, video, metadata, sender identity, voiceprint characteristics, facial characteristics, behavioral patterns, context, urgency language, and content-consistency signals to determine a risk status.

In another embodiment, a user interface displays one or more trust indicators and may include visual states such as green for likely human or low-risk, yellow or blue for AI-assisted or inconclusive content, and red for manipulated or high-risk content. The system may also display explanatory language that describes why a warning was generated.

In another embodiment, a user override module permits a user to pause an interaction, freeze content, block a source, save a report, replay or review the interaction, or otherwise neutralize a suspicious communication before harm occurs.

In another embodiment, a context-aware risk scoring engine adjusts classification thresholds based on content type, sender history, user preferences, user age, parental settings, institutional policies, or other safety settings.

In another embodiment, the system may operate through a mobile app, browser extension, share extension, video-call overlay, messaging integration, or operating-system interface to protect a user while digital content is being viewed or received.

### BRIEF DESCRIPTION OF THE DRAWINGS

FIG. 1 illustrates an example mobile user interface of an AI AWARE system displaying classification indicators and freeze and override controls.

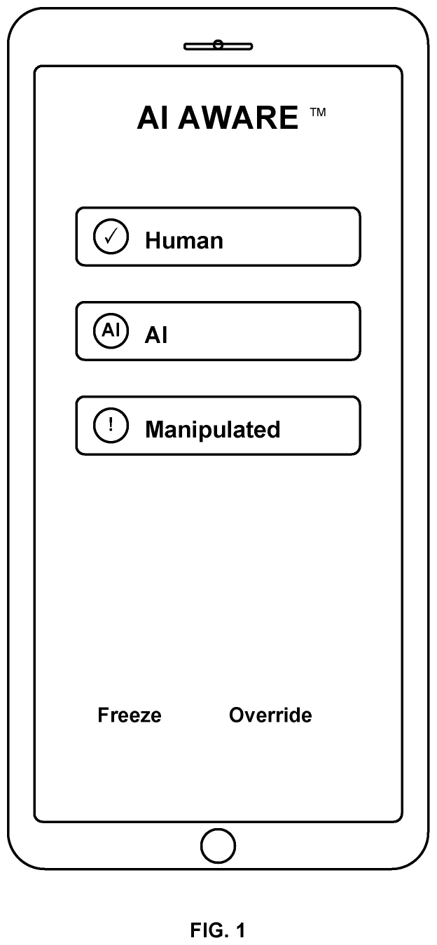

FIG. 2 illustrates an example system workflow for receiving content input, analyzing AI or manipulation signals, classifying risk, displaying an alert, and executing a user-selected response.

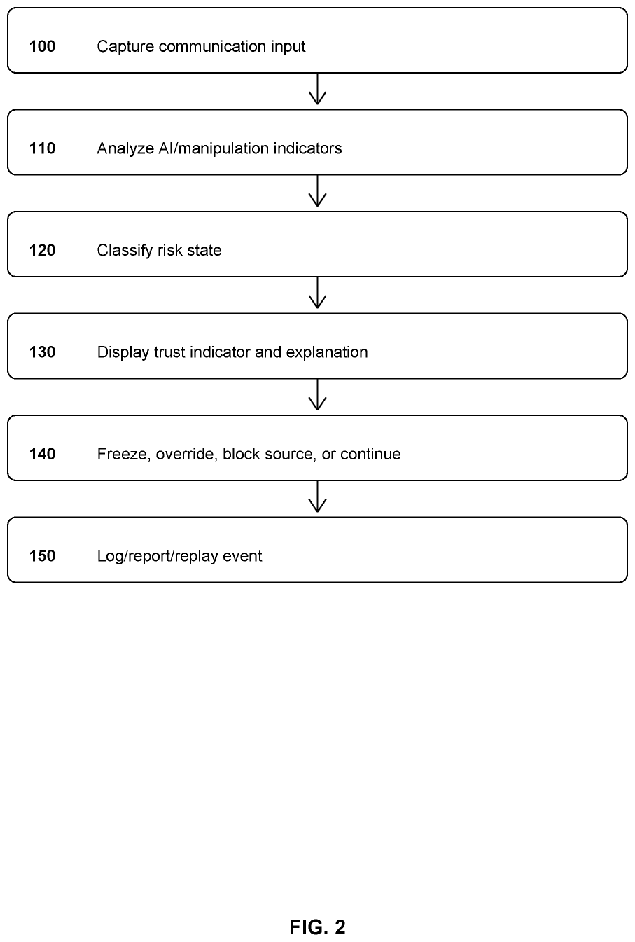

### DETAILED DESCRIPTION OF THE INVENTION

### System Overview

The AI AWARE system may include a detection engine, classification module, user-interface module, risk scoring module, override module, reporting module, and one or more communication interfaces. The system may execute locally on a user device, remotely on a server, or through a hybrid architecture.

The system may receive input from text messages, e-mail, social media posts, web pages, screenshots, images, audio files, video files, live video streams, browser sessions, video calls, or other digital communications.

### Detection Engine

The detection engine may analyze a plurality of signals including linguistic patterns, metadata, compression artifacts, visual inconsistencies, facial or voice irregularities, sender identity mismatch, abnormal urgency, repeated persuasion, link behavior, source reputation, and cross-platform consistency.

The detection engine may use rules, machine-learning models, biometric comparison, content-origin analysis, media forensics, or combinations of these techniques. In some embodiments, the detection engine produces confidence values for multiple possible classifications rather than a single binary result.

### Classification Module

The classification module may convert detection-engine outputs into a user-facing classification. For example, the classification module may classify a communication as likely human, AI-assisted, AI-generated, manipulated, suspicious, or inconclusive.

In some embodiments, the classification module applies gating rules that prevent a low-risk or human classification when contradictory metadata, captions, identity inconsistencies, or detected manipulation signals are present.

### User Interface and Visual Indicators

The user interface may present a simple trust indicator that is understandable to non-technical users. The interface may include icons, colors, labels, banners, overlays, or cards indicating the detected status of the communication.

The user interface may provide explanatory text, such as that the content shows patterns consistent with AI generation, manipulation, impersonation, or elevated persuasion risk. The system may avoid absolute certainty language when the evidence is inconclusive.

### Voiceprint and Identity Warning Module

The system may compare an incoming voice, face, sender profile, or identity signal against known or expected characteristics. If a mismatch is detected, the system may issue a warning, request additional verification, or prevent a high-risk action.

The identity warning module may be used to detect voice cloning, deepfake impersonation, false account identity, spoofed sender information, or fraudulent requests that appear to originate from a trusted person.

### Freeze Interaction Feature

The freeze interaction feature may pause an interaction, prevent the user from clicking a suspicious link, mute audio, freeze video, temporarily halt message replies, or otherwise interrupt the communication pending user confirmation.

The freeze function may be triggered automatically by the system when a risk score exceeds a threshold, or manually by the user through a displayed control.

### Override and Block Source Functions

The override module may permit a user to continue, block, report, quarantine, or dismiss a detected communication. The block-source function may disable or limit further interaction with a suspicious sender, URL, account, file, source, or communication channel.

In some embodiments, override decisions are recorded in a log for later review by the user, a parent, a guardian, an enterprise administrator, or another authorized reviewer.

### Context-aware Risk Scoring

The system may adjust thresholds based on the content category, user profile, relationship to the sender, urgency level, financial context, health context, political context, age of the user, or history of prior interactions.

For example, a request involving money, credentials, travel, private images, health decisions, or emergency action may trigger a higher warning level than ordinary low-risk conversation.

### Replay and Reporting Mode

The system may store timestamped logs, screenshots, excerpts, signal summaries, or other evidence associated with a detected event. A replay mode may allow a user to review what happened and understand why the system generated a warning.

Reports may be exported for user records, parental review, enterprise compliance, or legal defense, subject to privacy and consent settings.

### Browser, Messaging, and Video-layer Integration

The system may operate through share sheets, browser extensions, messaging-app integrations, video-call overlays, operating-system hooks, or other interface layers. The system may provide warnings while the user is viewing a web page, message, post, video, or live communication.

In some embodiments, the system overlays trust indicators on or near content without blocking the underlying application unless the user or system selects a freeze, block, or override action.

### Compliance and Safety Mode

The system may maintain audit logs and apply configurable policy settings for families, schools, businesses, governments, or other organizations. The system may operate in a discreet mode where warnings are delivered privately to avoid alerting a malicious actor or monitored party.

The system may be configured to protect vulnerable users, including children, older adults, or persons at increased risk of fraud, manipulation, blackmail, or impersonation.

1. A computer-implemented system for identifying artificial-intelligence-originated or manipulated communications, comprising: one or more processors; a detection engine configured to receive communication input from at least one of text, audio, image, video, browser, messaging, or social-media sources; a classification module configured to analyze the communication input and classify the communication as one of likely human, artificial-intelligence-assisted, artificial-intelligence-generated, manipulated, suspicious, or inconclusive; a user-interface module configured to display a visual trust indicator corresponding to the classification; and an override module configured to initiate at least one protective action selected from pausing the communication, freezing the communication, blocking a source, generating a warning, saving a report, or permitting user-authorized continuation.

2. The system of claim 1, wherein the detection engine analyzes at least one of linguistic patterns, voice characteristics, facial characteristics, metadata, sender identity, compression artifacts, source reputation, link behavior, urgency language, or cross-platform consistency.

3. The system of claim 1, wherein the user-interface module displays different visual states for likely human content, artificial-intelligence-associated content, suspicious content, manipulated content, or inconclusive content.

4. The system of claim 1, further comprising a voiceprint or identity warning module configured to detect a mismatch between an incoming communication and an expected voice, face, sender, account, or identity profile.

5. The system of claim 1, wherein the classification module applies a gating rule that prevents a low-risk classification when contradictory metadata, manipulation signals, identity inconsistencies, or suspicious-context indicators are detected.

6. The system of claim 1, wherein the override module includes a freeze interaction feature that temporarily prevents user action on a suspicious communication until the user confirms whether to proceed.

7. The system of claim 1, wherein the override module includes a block-source feature configured to restrict further interaction with a suspicious account, sender, URL, file, message source, or communication channel.

8. The system of claim 1, further comprising a context-aware risk scoring engine configured to adjust classification thresholds based on a user profile, content category, urgency level, financial context, health context, age setting, parental setting, enterprise policy, or prior interaction history.

9. The system of claim 1, further comprising a reporting module configured to store timestamped event data, signal summaries, user actions, screenshots, excerpts, or replay information associated with a detected communication.

10. The system of claim 1, wherein the system is implemented through at least one of a mobile application, browser extension, messaging integration, share extension, video-call overlay, or operating-system interface.
